(19) United States
(12) Patent Application Publication
(10) Pub. No.: US 2016/0342923 A1
(43) Pub. Date: Nov. 24, 2016

(54) DISPLAY SYSTEMS AND METHODS

(71) Applicant: Wal-Mart Stores, Inc., Bentonville, AR (US)

(72) Inventors: Matthew Allen Jones, Bentonville, AR (US); Nicholaus Adam Jones, Fayetteville, AR (US); Robert James Taylor, Rogers, AR (US)

(21) Appl. No.: 15/158,427

(22) Filed: May 18, 2016

Related U.S. Application Data
(60) Provisional application No. 62/163,669, filed on May 19, 2015.

(51) Int. Cl. G06Q 10/06; G06F 17/30; G06F 3/0484; G06K 7/01

(52) U.S. Cl. CPC G06Q 10/06398; G06K 7/01; G06F 17/30867; G06F 3/0484

(57) ABSTRACT

Exemplary embodiments are directed to display systems and methods. A user interface including a graphical representation of a queue is generated, where the graphical representation indicates at least a queue number. One or more databases are queried to retrieve one or more metrics therefrom. The retrieved metrics are converted into a parameter indicating a speed for the queue or statistics associated with the queue operator. A graphical representation is rendered on the user interface indicating the parameter for the queue.

### RELATED APPLICATION

This application claims priority to U.S. Provisional Patent Application No. 62/163,669 filed on May 19, 2015, which is hereby incorporated by reference in its entirety.

### BACKGROUND

It can be difficult for individuals to identify queues that will provide a fast or good experience because individuals typically cannot see or readily view the characteristics of the queues.

### SUMMARY

In one embodiment, a method for controlling a display to render data related to one or more queues is provided. The method includes generating a user interface including a graphical representation of a checkout lane. The graphical representation indicates at least a checkout lane number for the checkout lane. The method further includes querying one or more databases to retrieve one or more metrics therefrom, where the metrics include at least a cashier satisfaction rating for a cashier operating the checkout lane, and converting the retrieved metrics into a checkout lane parameter indicating a speed for the checkout lane or statistics associated with the cashier operating the checkout lane. The method further includes rendering a graphical representation on the user interface indicating the checkout lane parameter for the checkout lane and the cashier satisfaction rating.

In another embodiment, a system for controlling a display to render data related to one or more queues is provided, where the system includes a memory and a processor configured to execute instructions stored in the memory. Execution of the instructions stored in memory causes the system to generate a user interface including a graphical representation of the checkout lane, where the graphical representation indicates at least a checkout lane number for the checkout lane. The instructions further causes the system to query one or more databases to retrieve one or more metrics therefrom, where the metrics includes at least a cashier satisfaction rating for a cashier operating the checkout lane, convert the retrieved metrics into a checkout lane parameter indicating a speed for the checkout lane or statistics associated with the cashier operating the checkout lane, and render a graphical representation on the user interface indicating the checkout lane parameter for the checkout lane and the cashier satisfaction rating.

In yet another embodiment, a non-transitory machine-readable medium storing instructions executable by a processing device is provided, where execution of the instructions causes the processing device to implement a method for controlling a display to render data related to one or more queues. The method includes generating a user interface including a graphical representation of the checkout lane, where the graphical representation indicates at least a checkout lane number for the checkout lane. The method further includes querying one or more databases to retrieve one or more metrics therefrom, where the metrics include at least a cashier satisfaction rating for a cashier operating the checkout lane, converting the retrieved metrics into a checkout lane parameter indicating a speed for the checkout lane or statistics associated with the cashier operating the checkout lane, and rendering a graphical representation on the user interface indicating the checkout lane parameter for the checkout lane and the cashier satisfaction rating.

In another embodiment, a system for controlling a display to render data related to one or more queues is provided. The system includes means for generating a user interface including a graphical representation of a checkout lane, where the graphical representation indicates at least a checkout lane number for the checkout lane. The system further includes means for querying one or more databases to retrieve one or more metrics therefrom, where the metrics include at least a cashier satisfaction rating for a cashier operating the checkout lane. The system further includes means for converting the retrieved metrics into a checkout lane parameter indicating a speed for the checkout lane or statistics associated with the cashier operating the checkout lane, and means for rendering a graphical representation on the user interface indicating the checkout lane parameter for the checkout lane and the cashier satisfaction rating.

### BRIEF DESCRIPTION OF DRAWINGS

Some embodiments are illustrated by way of example in the accompanying drawings and should not be considered as a limitation of the invention:

FIG. 1 is a block diagram showing a parameter system implemented in modules, according to an example embodiment;

FIG. 2 is a flowchart showing an example method for controlling a display to render data related to one or more queues, according to an example embodiment;

FIG. 3 illustrates an example user interface for displaying data related to one or more queues, according to an example embodiment;

FIG. 4 illustrates a network diagram depicting a system for controlling a display to render data related to one or more queues, according to an example embodiment;

FIG. 5 is a block diagram of an example computing device that may be used to implement exemplary embodiments of the parameter system described herein;

FIG. 6A is a schematic diagram of a system implemented according to an example embodiment; and

FIG. 6B is a schematic diagram of a system shown in FIG. 6A displaying an arrangement of sensors, implemented according to an example embodiment.

### DESCRIPTION OF EXEMPLARY EMBODIMENTS

Described in detail herein are systems and methods for displaying queue information via a parameter system. Exemplary embodiments provide methods, systems, and computer-readable mediums for controlling a display to render data related to one or more queues. In an example, a user interface is generated, and includes a graphical representation of a queue with at least a queue number for the queue. A database is queried to retrieve metrics relating to the queue and/or the operator associated with the queue. The metrics includes at least a satisfaction rating for the operator. The metrics are converted into a parameter that indicates a speed for the queue and/or indicates statistics for the queue. A graphical representation is rendered on the user interface indicating the parameter for the queue and the satisfaction rating.

The systems and methods described herein implement a mechanism for providing information related to queues. The information is provided to users via a user interface and graphical representations rendered on a display device. In an example embodiment, the display device is provided in an area proximate to the queues, so that it is easily visible to a user as he or she approaches the queuing area. A user can easily view the information in the user interface and the graphical representations, and identify for themselves an appropriate queue. Sometimes a user may be interested in a quickly moving through a queue. At other times a user may be interested in experiencing a highly rated or recommended operator. The systems and methods described herein provide a user interface that displays relevant information to aid the user in choosing a queue based on their interest. The information and data provided via the user interface can be rendered based on, as non-limiting examples, data collected from past queue transactions, data from present queue conditions, and/or data collected indicating operators' performance for a queue transaction. By providing information for queues, exemplary embodiments described herein can be implemented to reduce queue delays and improve a user's experience.

The following description is presented to enable any person skilled in the art to create and use a computer system configuration and related method and article of manufacture to control a display to render data related to one or more queues. Various modifications to the example embodiments will be readily apparent to those skilled in the art, and the generic principles defined herein may be applied to other embodiments and applications without departing from the spirit and scope of the present disclosure. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

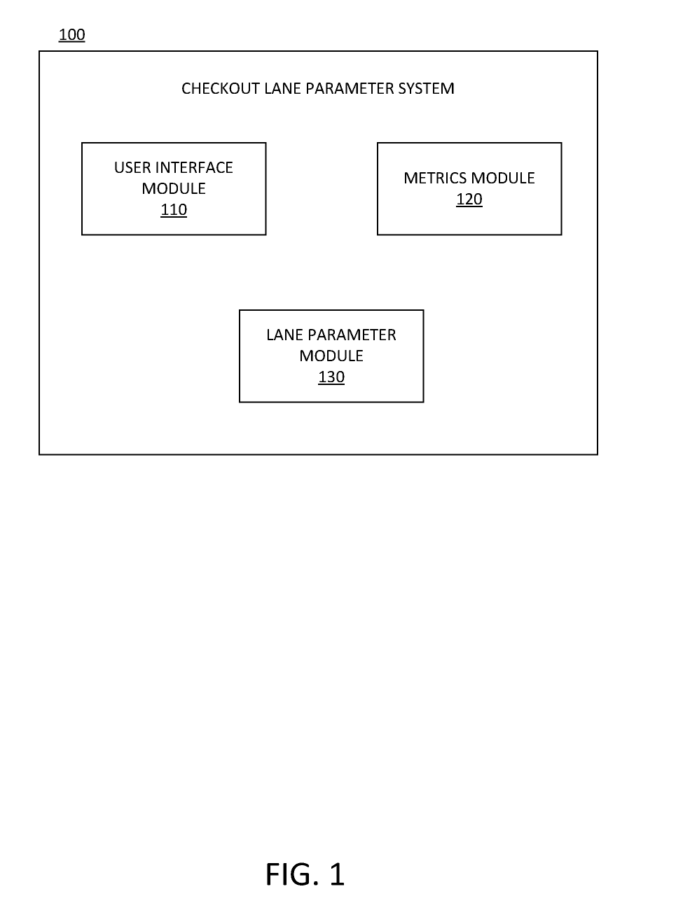

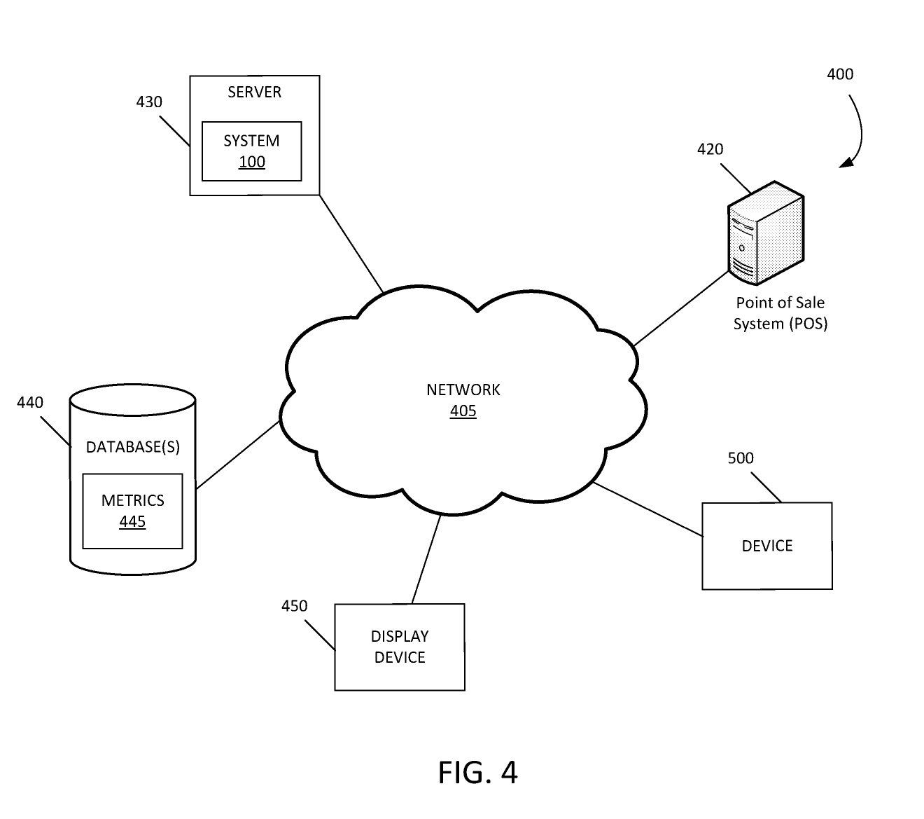

FIG. 1 is a block diagram showing example modules 110, 120, 130 that can be included in a checkout lane parameter system 100, according to an example embodiment. The modules may be implemented using a device and/or a system, such as but not limited to device 500 and/or POS system 420 described below relative to FIG. 4. The modules may include various circuits, circuitry and one or more software components, programs, applications, apps or other units of code base or instructions configured to be executed by one or more processors included in device 500 or POS system 420. In other embodiments, one or more of modules 110, 120, 130 may be included in server 430, while others of the modules 110, 120, 130 can be provided in device 500 or POS system 420. Although modules 110, 120, 130 are shown as distinct modules in FIG. 1, it should be understood that the procedures and/or computations performed using modules 110, 120, 130 may be implemented using fewer or more modules than illustrated. It should be understood that any of modules 110, 120, 130 may communicate with one or more components included in system 400, such as but not limited to database(s) 440, server 430, device 500, or POS system 420. In the example of FIG. 1, the checkout lane parameter system 100 includes a user interface module 110, a metrics module 120, and a lane parameter module 130.

The user interface module 110 may be a hardware-implemented module that may be configured to generate and manage a user interface, and render graphical representations on the user interface. The metrics module 120 may be a hardware-implemented module that may be configured to store and manage metrics related to a checkout lane and a cashier. The lane parameter module 230 may be a hardware-implemented module that may be configured to retrieve and analyze metrics related to the checkout lane and the cashier, and convert the metrics into a checkout lane parameter indicating a speed for the checkout lane or statistics for the checkout lane.

The user interface module 110 also can be configured to provide means for generating a user interface including a graphical representation of a checkout lane, where the graphical representation indicating at least a checkout lane number for the checkout lane, and means for rendering a graphical representation on the user interface indicating the checkout lane parameter for the checkout lane and the cashier satisfaction rating. The metrics module 120 also can be configured to provide means for querying one or more databases to retrieve one or more metrics therefrom, where the metrics including at least a cashier satisfaction rating for a cashier operating the checkout lane. The lane parameter module 130 can be configured to provide means for converting the retrieved metrics into a checkout lane parameter indicating a speed for the checkout lane or statistics associated with the cashier operating the checkout lane.

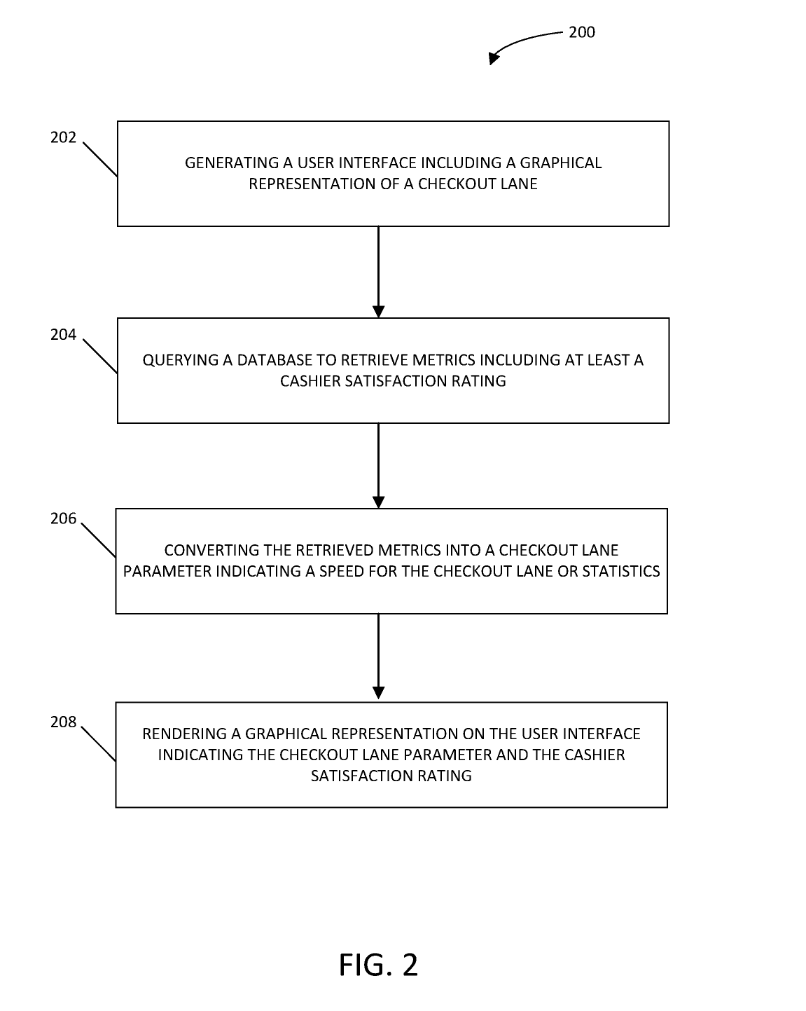

FIG. 2 is a flow chart showing an example method 200 for controlling a display to render data related to one or more checkout lanes in a store. The method 200 may be performed using the example checkout lane parameter system 100 shown in FIG. 1.

In operation 202, the user interface module 110 generates a user interface including a graphical representation of a checkout lane, where the graphical representation indicates at least a checkout lane number for the checkout lane. In an example embodiment, the user interface includes graphical representations for checkout lanes that are open to perform checkout transactions, and have a cashier operating the POS system at the checkout lane. In some embodiments, the user interface may also include graphical representations for self-checkout lanes, which do not employ a cashier to perform a checkout transaction.

In operation 204, the metrics module 120 queries a database, for example database 440 shown in FIG. 4, to retrieve metrics including at least a cashier satisfaction rating for a cashier operating the checkout lane. For example, when a cashier logs into a POS system at a checkout lane, the metrics module 120 queries the database for various metrics associated with the log-in information for the cashier. The database may store data related to various checkout transactions at a store for various cashiers working at a store. The data may be analyzed and processed to derive various metrics for cashiers and checkout transactions at a store. The metrics may include, but are not limited to, a cashier satisfaction rating, a cashier efficiency for a checkout transaction, a number of shopping carts present in line at a checkout lane, a number of shopping baskets present in line at a checkout lane, a quantity of items present in line at a checkout lane, an average number of items in a shopping cart, an average number of items in a shopping basket, an average number of items for a customer without a shopping cart or basket, and the like. The average number of items in a shopping cart, shopping basket, or for a customer without a cart or basket, may be determined based on data collected from past checkout transactions for a store. The average number of items for a cart, basket, or a customer without a cart or basket may vary for each store. The average number of items for a cart, basket, or a customer without a cart or basket may also vary based on the time of the day or the day of the week.

The cashier satisfaction rating for a cashier may be stored in the database based on data and/or information provided by a customer in a survey that indicates the customer's satisfaction with a cashier's performance. The survey may have various categories and ratings from 1 to 5 for each category. The cashier satisfaction rating may be an average of the ratings provided by multiple customers via the survey. In other embodiments, a customer may be able to provide his or her satisfaction rating for a cashier via an input device located near the checkout lane in the store.

In an example embodiment, the method 200 may further include detecting a quantity of shopping carts and a quantity of shopping baskets in the checkout lane using a machine vision device or system. The metrics module 120 further retrieves metrics related to the quantity of shopping carts and the quantity of shopping baskets in the checkout lane. In another embodiment, the method 200 may further include sensing, via one or more sensors located at the checkout lane, a quantity of items in one or more shopping carts or shopping baskets waiting in line at the checkout lane. The metrics module 120 further retrieves metrics related to the quantity of items in the shopping carts or shopping baskets in the checkout lane. In some embodiments, the quantity of items may be an estimate or an approximate number of items in the shopping carts or shopping baskets at the checkout lane.

In an example embodiment, the one or more sensors located at the checkout lane may include optical or acoustic sensors to sense and estimate a number of items in the shopping cart or shopping basket. In another embodiment, the one or more sensors located at the checkout lane may include an image capturing device, for example, a camera. The metrics module 120 may further receive image data from the image capturing device located near the checkout lane, and process the image data to determine a number of items in the shopping cart or shopping basket at the checkout lane.

In some embodiments, acoustic sensors may and/or machine vision (e.g., based on video record by an imaging capturing device) can be used to calculate the number of items in the cart. As one example, acoustic sensors can be positioned at a checkout to transmit an acoustic signal and receive a reflected acoustic signal from which information associated with a fullness of a shopping cart or basket can be extracted or derived. As another example, machine vision be used to capture images via the image capturing device to determine the approximate height of the items in the shopping cart or shopping basket is one or more machine vision algorithms. The metrics module 120 may receive the approximate height determined using the machine vision algorithms and/or the acoustic sensors, and generate correlation data by correlating the approximate height to metrics consisting of average heights of items. The metrics module 120 can use the correlation data determine the amount of items in the shopping cart or shopping basket. The metrics module 120 may further adjust the metrics consisting of average heights according to the new data collected from machine vision.

In some embodiments, the sensors at the checkout lane may be configured to sense how full the shopping cart or shopping basket is. For example, the sensors may be used to sense and indicate whether a shopping cart or basket is completely full with items, three-quarters full with items, half-way full with items, one-quarter full with items, or mostly empty (only a few items in the cart or basket).

The metrics may also include a cashier efficiency metric for the casher operating the checkout lane, where the cashier efficiency metric may indicate the cashier's efficiency at performing checkout transactions for a customer. The cashier efficiency metric may be determined based on an average speed of a cashier for scanning items. The cashier efficiency metric may also be determined based on the average amount of time a cashier spends performing a checkout transaction for a customer. Alternatively, the cashier efficiency metric may be based on the number of items scanned over a period of time.

In an example embodiment, the metrics module 120 may further be configured to determine the speed of the belt associated with the checkout lane. The metrics further include the belt speed for the cashier operating the checkout lane. The belt speed may indicate how fast a cashier is processing or scanning items.

The metrics module 120 may further be configured to receive an input from the cashier operating the checkout lane or any other suitable individual (e.g., another employee, such as a manager or supervisor), where the input indicates a number of items in the shopping carts or shopping baskets in the checkout lane. The input may indicate an approximate number of items. Alternatively, the input may indicate an approximate fullness of the shopping carts or shopping baskets. For example, the input may indicate whether the shopping basket or shopping cart is completely full with items, three-quarters full with items, half-way full with items, one-quarter full with items, or mostly empty (only a few items in the cart or basket). The cashier may enter such input in person via the POS system at the checkout lane. Alternatively, the cashier may enter such input via a separate interface device and/or another suitable individual may enter such input from a remote or central location based on information displayed on an video interface in a remote or central location that monitors the checkout lane.

In operation 206, the lane parameter module 130 converts the retrieved metrics into a checkout lane parameter indicating a speed for the checkout lane or statistics associated with the cashier operating the checkout lane. The checkout lane parameter may also indicate a checkout speed for the cashier operating the checkout lane. The speed for the checkout lane may relate to how fast the queue at the checkout lane is progressing at a present time. The checkout speed for the cashier may relate to an average checkout speed calculated for the cashier based on past transactions performed by the cashier.

In an example embodiment, the metrics module 120 retrieves metrics indicating a quantity of items in line at a checkout lane, and metrics indicating a checkout speed for the cashier operating the checkout lane. The lane parameter module 130 converts these metrics to a speed of the checkout lane by dividing the quantity of items at the checkout lane by the checkout speed for the cashier. In some embodiments, the metrics module 120 retrieves an average number of items for a shopping cart, an average number of items for a shopping basket, an average number of items for a customer without a cart or basket, and a number of shopping carts and shopping baskets, and customers without any cart or basket in the checkout lane. The lane parameter module 130 may convert these retrieved metrics into a checkout lane parameter indicating a speed of the checkout lane.

In operation 208, the user interface module 110 renders a graphical representation on the user interface indicating the checkout lane parameter for the checkout lane and the cashier satisfaction rating. The user interface module 110 may be configured to display the user interface on a display device, for example display device 450 described below. The display device may be located in proximity to a plurality of checkout lanes at a store, so that it is visible to a customer who is ready to checkout. In some embodiments, the user interface module 110 may be configured to display the user interface on a mobile device of a customer via, for example, an App (including processor-executable instructions) installed on the mobile device of the customer. In other embodiments, the user interface module 110 may be configured to display the user interface on a plurality of display devices located at each of the plurality of checkout lanes at a store.

A graphical representation for the cashier satisfaction rating may be rendered based on an average of all of the ratings provided by customers for the cashier. In some embodiments, the cashier satisfaction rating is based on an average of ratings provided by customers most recently. In some embodiments, the graphical representation for the cashier satisfaction rating can be rendered based on a satisfaction rating for the cashiers presently operating a checkout lane. For example, a cashier operating a checkout lane may have an average rating of 4, however, the rating of 4 is the highest among all of the cashiers presently operating a checkout lane. In that case, the graphical representation for the cashier satisfaction rating associated with that particular cashier indicates the highest possible cashier satisfaction rating; in this case the highest rating is 5. In some embodiments, if a cashier satisfaction rating is low for a particular cashier, then a graphical representation for a customer satisfaction rating is not rendered in the user interface for that cashier.

As a non-limiting example, the lane parameter module 130 may convert the metrics relating to a cashier efficiency into a checkout lane parameter or statistics associated with the cashier indicating a checkout speed for the cashier. The user interface module 110 renders a graphical representation of the checkout speed for the cashier. The graphical representation for the cashier checkout speed may be rendered as text indicating the checkout speed of the cashier at a particular checkout lane. In some embodiments, the cashier may be a new cashier, and may not have enough data related to checkout transactions performed by him or her. In that case, the graphical representation for the cashier checkout speed may indicate that the cashier is a new cashier. In some embodiments, one of the cashiers operating the open checkout lanes may be designated the fastest cashier based on the checkout speed for the other cashiers.

As another non-limiting example, the lane parameter module 130 may be configured to convert the metrics relating to belt speed or the number of items, or both, into a checkout lane parameter indicating a speed for the checkout lane. The user interface module 110 can be configured to render a graphical representation of the speed for the checkout lane. The graphical representation for the speed for the checkout lane may be rendered as an array of colored icons, where, for example, a green icon indicates a fast checkout lane, while a red icon indicates a slow checkout lane. The speed of the checkout lane may be fast or slow based on the number of customers in line (indicated by the quantity of shopping carts and shopping baskets in line) and on how full each shopping cart or basket is (indicated by the quantity of items).

As another non-limiting example, the lane parameter module 130 may be configured to convert the metrics relating to the quantity of shopping carts and shopping baskets to a checkout lane parameter indicating a speed for the checkout lane. The user interface module 110 renders a graphical representation for this checkout lane parameter, where the graphical representation may be rendered as a shopping cart icon or shopping basket icon to indicate a number of shopping carts and shopping baskets in line at the checkout lane.

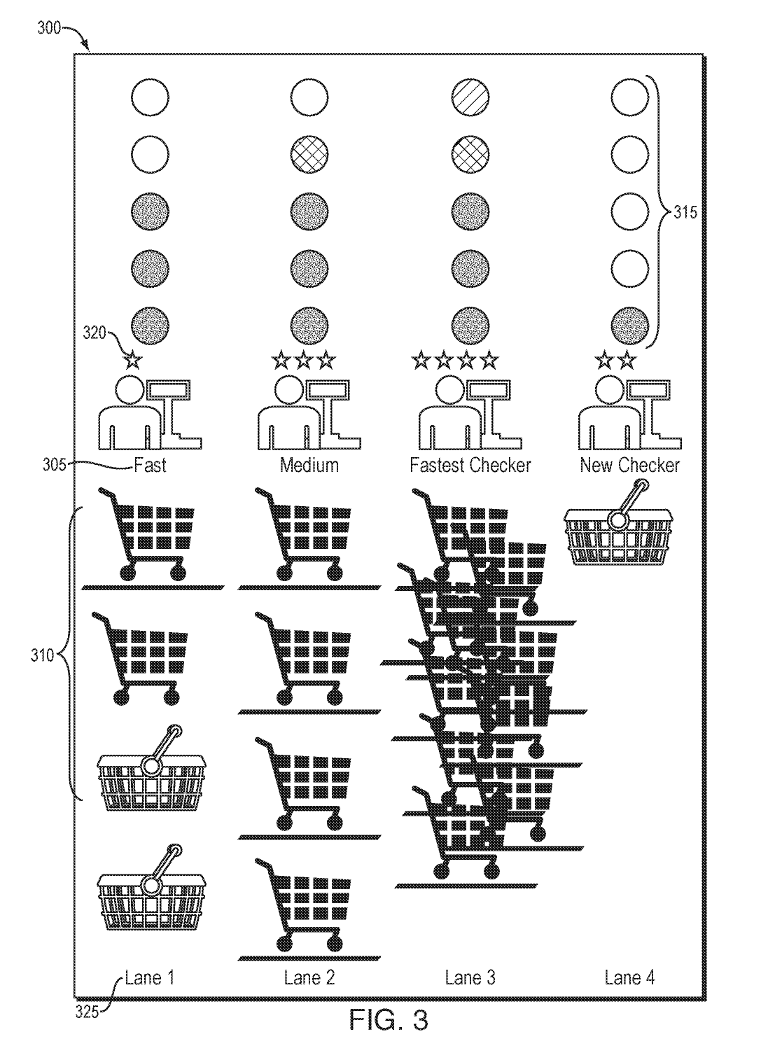

FIG. 3 illustrates an example user interface 300 for displaying data related to one or more checkout lanes in a store, according to an example embodiment. As shown in FIG. 3, the user interface 300 includes graphical representations for one or more checkout lanes, where the graphical representation includes at least the checkout lane numbers rendered as text 325. The user interface 300 further includes graphical representations, rendered as text 305, for indicating statistics associated with the cashier operating a checkout lane. Here, text 305 indicates an average checkout speed of the cashier which is determined by the lane parameter module 130 by converting the various metrics retrieved by the metrics module 120. The user interface 300 also includes graphical representations, rendered as icons 310, for indicating a number of shopping carts or shopping baskets in line at the checkout lane. The user interface 300 further includes graphical representations, rendered as icons 315, for indicating a speed for the checkout lane. Here, icons 315 may be of different patterns or colors to indicate the speed for the checkout lane, for example, a red colored icon (represented by the icon with angle lines pattern) indicates a slow checkout lane, while a green colored icon (represented by the icon with shaded pattern) indicates a fast checkout lane. The icons 315 may also include yellow icons or orange icons (represented by the icon with a crisscross pattern). Graphical representations for the cashier satisfaction rating for a cashier is also included in the user interface 300, and may be rendered as star icons 320.

In this manner, the systems and methods described herein control a display to render data related to one or more checkout lanes in a store. The systems and methods described herein can reduce a customer's wait time in a checkout lane by providing data and information to the customer related to a speed of a checkout lane based on various metrics for the checkout lane. Providing data and information related to checkout lanes enables a customer to more easily choose a checkout lane for a potentially faster checkout experience. The systems and methods described herein can also provide a better checkout experience to a customer by providing data and information to the customer related to a cashier operating a checkout lane. This data and information, including a cashier satisfaction rating, enables a customer to easily choose a checkout lane for a great checkout experience. The data and information provided in the user interface rendered by the systems and methods described herein is very valuable, especially in large stores, in enabling the customer to identify the ‘best’ checkout lane.

FIG. 4 illustrates a network diagram depicting a system 400 for controlling a display to render data related to one or more checkout lanes in a store, according to an example embodiment. The system 400 can include a network 405, a device 500, a point-of-sale (POS) system 420, a server 430, database(s) 440, and a display device 450. Each of the device 500, POS system 420, server 430, databases 440, and display device 450 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

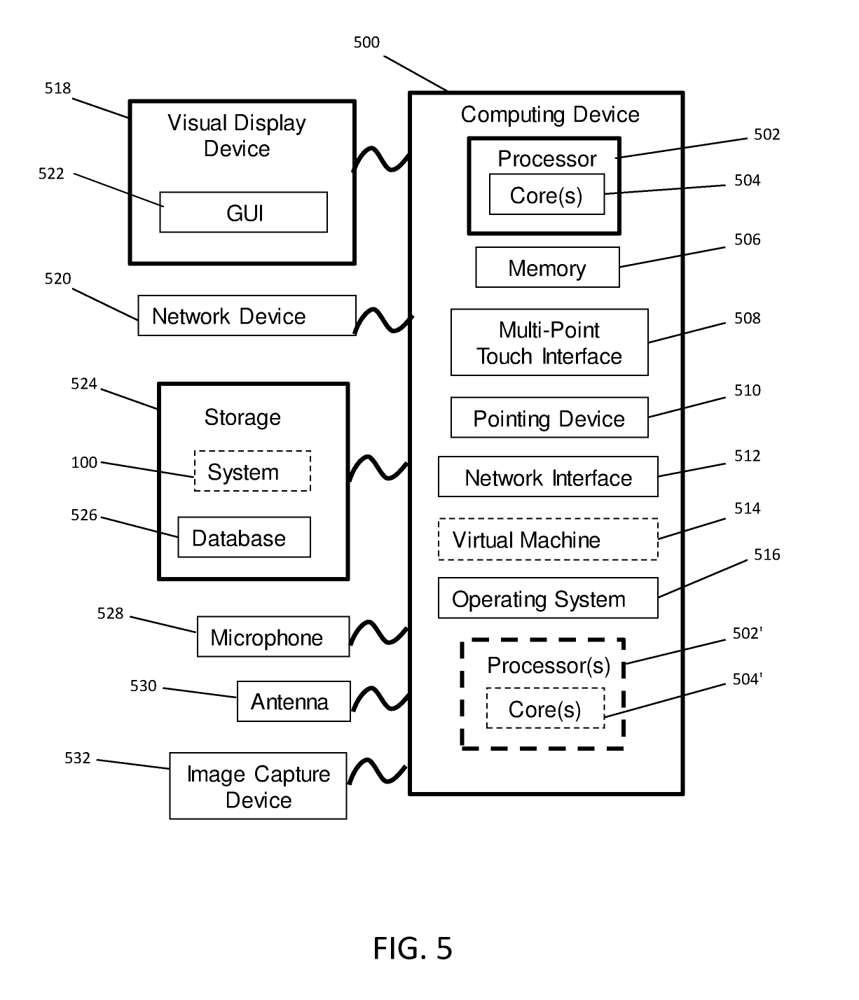

The device 500 may comprise, but is not limited to, work stations, computers, general purpose computers, Internet appliances, hand-held devices, wireless devices, portable devices, wearable computers or devices, cellular or mobile phones, portable digital assistants (PDAs), smartphones, tablets, ultrabooks, netbooks, laptops, desktops, multi-processor systems, microprocessor-based or programmable consumer electronics, network PCs, mini-computers, and the like. The components of device 500 are described in further detail with relation to FIG. 5.

The POS system 420 may comprise, but is not limited to, cash registers, work stations, computers, general purpose computers, Internet appliances, hand-held devices, wireless devices, portable devices, wearable computers or devices, cellular or mobile phones, portable digital assistants (PDAs), smartphones, tablets, ultrabooks, netbooks, laptops, desktops, multi-processor systems, microprocessor-based or programmable consumer electronics, network PCs, mini-computers, and the like. The POS system 420 is part of a store infrastructure and aid in performing various transactions related to sales and other aspects of a store. Being part of a store's infrastructure, the POS system 420 may be installed within the store or they may be installed or operational outside of the store. For example, the POS system 420 may be a mobile device that a store employee can use outside of the store to perform transactions or other activities. In another example, the POS system 420 may be a kiosk installed outside the store. Similarly, the POS system 420 may be a mobile device that can be used within the store, and is not physically installed or attached to one particular location within the store. The POS system 420 can include one or more components described in relation to computing device 500 shown in FIG. 5.

The POS system 420 may also include various external or peripheral devices to aid in performing sales transactions and other duties. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like.

Each of the device 500 and POS system 420 may connect to network 405 via a wired or wireless connection. Each of the device 500 and POS system 420 may include one or more applications or systems such as, but not limited to, a sales transaction application, a cashier performance application, a customer review application, a user interface application, a checkout lane parameter system, and the like. In an example embodiment, the device 500 may perform all the functionalities described herein. In another example embodiment, the POS system 420 may perform all the functionalities described herein.

In other embodiments, the checkout lane parameter system may be included on either device 500, or POS system 420, or on both device 500 and POS system 420, and the server 430 performs the functionalities described herein. In yet another embodiment, the device 500 or POS system 420 may perform some of the functionalities, and server 430 performs the other functionalities described herein. For example, device 500 or POS system 420 may generate the user interface including a graphical representation of a checkout lane and render a graphical representation on the user interface indicating the checkout lane parameter and cashier satisfaction rating, while server 430 may query the databases to retrieve metrics including at least a cashier satisfaction rating and convert the metrics into a checkout lane parameter indicating a speed for the checkout lane or statistics for the checkout lane operated by the cashier.

The database(s) 440 may store data related to various metrics 445 for a checkout lane and a cashier as described herein. The display device 450 may be any device capable of displaying a graphical user interface, video data or image data, for example, a computer, a television, or a display monitor. In an example embodiment, the display device 450 may be a touch-screen display device.

Each of the server 430, database(s) 440, display device 450, is connected to the network 405 via a wired connection. Alternatively, one or more of the server 430, databases 440, and display device 450 may be connected to the network 405 via a wireless connection. Server 430 comprises one or more computers or processors configured to communicate with device 500, POS system 420, database(s) 430, and/or display device 450 via network 405. Server 430 hosts one or more applications or websites accessed by device 500 and POS system 420 and/or facilitates access to the content of database(s) 440. Server 430 also may include system 100 described herein. Database(s) 440 comprise one or more storage devices for storing data and/or instructions (or code) for use by server 430, device 500 and/or POS system 420. Database(s) 440 and server 430 may be located at one or more geographically distributed locations from each other or from device 500 and POS system 420. Alternatively, database(s) 440 may be included within server 430.

FIG. 5 is a block diagram of an exemplary computing device 500 that may be used to implement exemplary embodiments of the checkout lane parameter system 100 described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software for implementing exemplary embodiments of the checkout lane parameter system 100. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522, for example, user interface 300 shown in FIG. 3, that may be provided in accordance with exemplary embodiments. The computing device 500 may include other I/O devices for receiving input from a user, for example, a keyboard or any suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement exemplary embodiments of the checkout lane parameter system 100 described herein. Exemplary storage device 524 may also store one or more databases for storing any suitable information required to implement exemplary embodiments. For example, exemplary storage device 524 can store one or more databases 526 for storing information, such as cashier information, cashier performance metrics, checkout lane metrics, checkout lane information, item information, shopping cart or basket information, user interface information, and/or any other information to be used by embodiments of the system 100. The databases may be updated manually or automatically at any suitable time to add, delete, and/or update one or more data items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

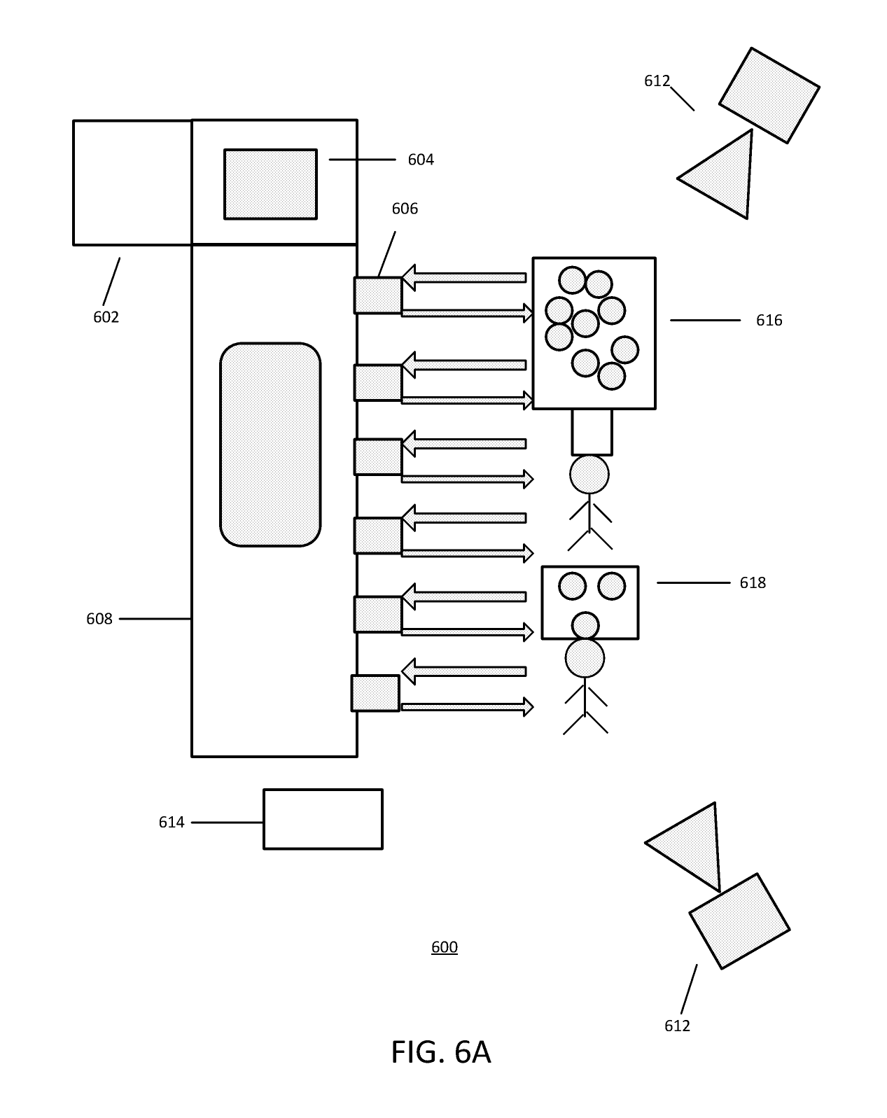

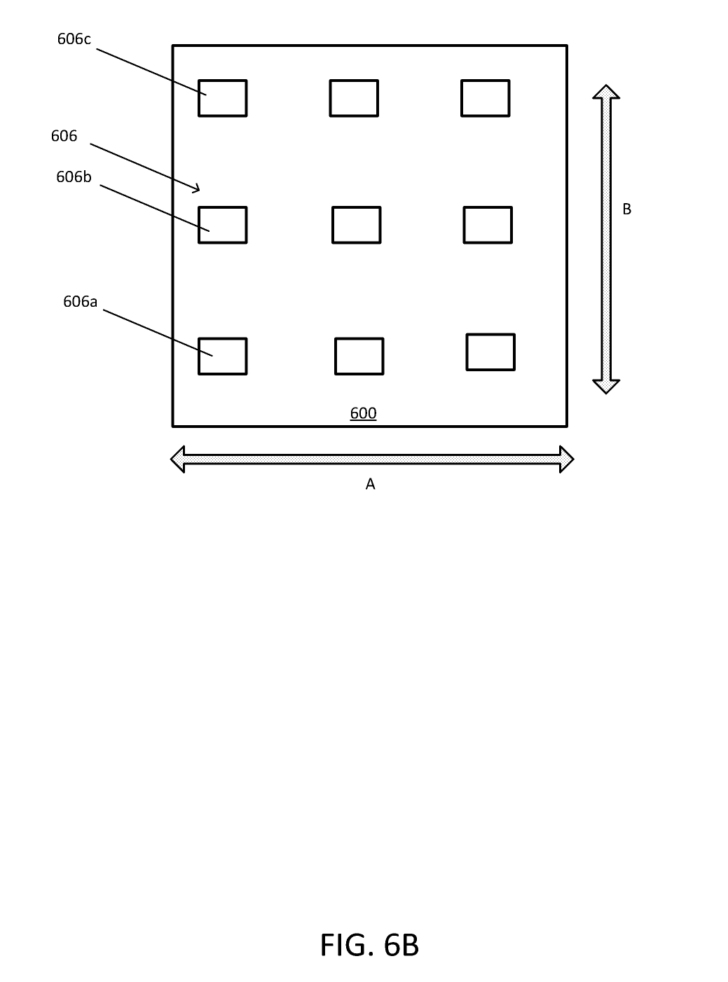

FIG. 6A illustrate a schematic diagram of a checkout lane system 600 implemented according to an example embodiment. FIG. 6B illustrates a schematic diagram of an exemplary arrangement of at least some of the sensors of the checkout lane 600. As shown in FIGS. 6A and 6B, the checkout lane system 600 can include a POS system 602, an item scanner/reader 604, sensors 606 (e.g., a bar code reader), a belt 608 for moving items towards the item scanner/reader 604, image capturing devices (e.g., cameras 612) for implementing machine vision monitoring of the checkout lane system 600 as described herein, and a display unit 614 that is separate and distinct from a display of the POS system 602. The checkout lane system 600 can be configured to implement embodiments described herein to provide information to customers via the display unit 614 regarding a queue associated with the checkout lane system 600 and/or the cashier operating the checkout lane 600. For example, the display 614 can be configured provide embodiments of the user interface for displaying data related to the checkout lane.

The sensors 606 can include optical and/or acoustic sensors that are disposed along a horizontal and/or vertically extent of the checkout lane as well as in an area adjacent to the checkout lane system 600 where a queue for the checkout lane system 600 may form. In some embodiments, the sensors 606 can include reflective-type sensors that transmit acoustic or electromagnetic radiation towards objects and receive reflected signals associated with the acoustic or electromagnetic radiation, where the reflected signals can be used by, e.g., the POS system 602 (or a system remote to, but in communication with the sensors 606 or the POS system 602) to estimate how many items are contained in shopping carts and shopping baskets in the queue for the checkout lane system 600 (e.g., in the shopping cart 616 and shopping basket 618) to capture the depth of the shopping cart 608 and shopping basket 610. For example, the presence or absence of a reflected signal or the time it takes to receive a reflected signal can be indicative of a degree to a shopping cart or shopping basket is filled. In some embodiments, the sensors 606 can include transmission-type sensors that include opposingly spaced transmitters and receivers, where acoustic or electromagnetic radiation is transmitted by the transmitters towards the receivers and the acoustic or electromagnetic radiation that reaches (or does not reach) the receivers can be used by, e.g., the POS system 602 (or a system remote to, but in communication with the sensors 606 or the POS system 602) to estimate how many items are contained in shopping carts and shopping baskets in the queue for the checkout lane system 600 (e.g., in the shopping cart 616 and shopping basket 618) to capture the depth of the shopping cart 608 and shopping basket 610. For example, the presence or absence of a received signal at the receiver can be indicative of a degree to a shopping cart or shopping basket is filled.

In the following example, FIG. 6B illustrates the sensors 606 as being laid out in an array along a longitudinal axes A and B, wherein in the present example, the longitudinal axis A corresponds to a horizontal axis and the longitudinal axis B corresponds to a vertical axis. The sensors 606 can be arranged to capture (from a side of the shopping carts) a degree to which the shopping carts and shopping baskets are filed. For example, in some embodiments, the sensor can include sensors 606a disposed horizontally along a lower portion of the arrange which can be disposed at a typical height of a bottom of a shopping cart (or at a specified height that is higher than the bottom of a shopping cart), sensors 606b can be disposed at a typical height corresponding to an intermediate height of a shopping cart, and sensors 606c can be disposed at a typical height of a top of a shopping cart (or at a specified height that is lower than the top of a shopping cart). In one exemplary operation, if the sensors 606a detect that items are in a shopping cart, but the sensors 606b and 606c do not, then the POS system 602 can estimate that the shopping cart is one third full; if the sensors 606a and 606b detect that items are in the shopping cart, the POS system 602 can determine that the shopping cart is two thirds full; and if the sensors 606a-c detect items in the shopping cart, then the POS system 602 can determine that the shopping cart is full.

In another example, FIG. 6B illustrates the sensors 606 as being laid out on the longitudinal axes A and B, wherein the longitudinal axes A and B correspond to horizontal axes generally defining a horizontal plane (e.g., parallel to a floor and/or ceiling). For example, the sensors 606 can be attached to a generally planar ceiling of the store to capture (from above the shopping carts) a degree to which the shopping carts and/or shopping baskets are filled. In one exemplary embodiment, the sensors will transmit acoustic or electromagnetic radiation downward from the ceiling of the store towards the shopping carts or shopping baskets. The sensors will determine the distance from the location of the sensors to the point at which the acoustic or electromagnetic radiation intersects with the shopping cart or shopping basket. The sensors will calculate the difference between the calculated height of the shopping cart and of the predetermined stored measurements (e.g., the distance from the sensors to the floor, the height of the shopping cart, or the height of the shopping basket) and use the difference to determine the degree to which the shopping carts and shopping baskets are filled.

In another exemplary operation, the system can include arrays of sensors disposed above and along-side a checkout lane. In some embodiments, the sensors can detect items in throughout the length of the shopping cart or shopping basket. For example, in FIG. 6B if the row of sensors including 606a detect that items are in a shopping cart, but the row of sensors including 606b and 606c do not, then the POS system 602 can estimate that the length of the shopping cart is one third full; if the row of sensors including 606a and 606b detect that items are in the shopping cart, the POS system 602 can determine that the length of the shopping cart is two thirds full; and if the all three rows of sensors including 606a-c detect items in the shopping cart, then the POS system 602 can determine that the length of the shopping cart is full. In one exemplary operation, if the row of sensors including 606a detect that items are in a shopping cart, but the row of sensors including 606b and 606c do not, then the POS system 602 can estimate that the length of the shopping cart is one third full; if the sensors 606a and 606b detect that items are in the shopping cart, the POS system 602 can determine that the length of the shopping cart is two thirds full; and if the sensors 606a-c detect items in the shopping cart, then the POS system 602 can determine that the length of the shopping cart is full. Furthermore, the sensors can use the calculated fullness of the length of the shopping cart or shopping basket, along with the calculated height of the items in the shopping cart or shopping basket to determine the fullness of the shopping cart or shopping basket.

While the present example embodiments shows sensors disposed at three heights, those skilled in the art will recognize that the sensors can be disposed at fewer or more heights to gains a resolution of the system. For example, if sensors are disposed at four heights, the system 600 can detect whether a shopping cart is a quarter full, half full, three quarters full, or full; and if sensors are disposed at eight heights, the system 600 can detect whether a shopping cart is an eighth full, a quarter full, half full, five-eighths full, three quarters full, or full; and so on.

In exemplary embodiments, the fullness of the shopping cart or basket may help determine the amount of items in the shopping cart or basket by using the metrics module 120. The determined fullness of the shopping cart or basket can be correlated to metrics comprising of average number of items based on fullness of shopping cart or basket. For example, a shopping cart is determined to be half-full and the metrics state that on average a half-full shopping cart holds 10 items then it is determined that the shopping cart most likely is holding 10 items. The actual number of items then scanned by the cashier from the shopping cart or basket is sent back to the metrics module to update the metrics comprising of the averages of number items based on fullness of shopping cart or basket.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method for controlling a display to render data related to one or more queues, the method comprising:
generating a user interface including a graphical representation of a checkout lane, the graphical representation indicating at least a checkout lane number for the checkout lane;
querying one or more databases to retrieve one or more metrics therefrom, the metrics including at least a cashier satisfaction rating for a cashier operating the checkout lane;
converting the retrieved metrics into a checkout lane parameter indicating a speed for the checkout lane or statistics associated with the cashier operating the checkout lane; and
rendering a graphical representation on the user interface indicating the checkout lane parameter for the checkout lane and the cashier satisfaction rating.

2. The method of claim 1, further comprising:
detecting a quantity of shopping carts and a quantity of shopping baskets in the checkout lane using machine vision,
wherein the metrics include the quantity of shopping carts and the quantity of shopping baskets in the checkout lane.

3. The method of claim 1, further comprising:
sensing a quantity of items in one or more shopping carts or shopping baskets waiting in line at the checkout lane,
wherein the metrics include the quantity of items in one or more shopping carts or shopping baskets in the checkout lane.

4. The method of claim 3, further comprising:
determining the number of items using data collected by one or more optical or acoustic sensors located at the checkout lane.

5. The method of claim 4, wherein the one or more sensors include an image capturing device and the method further comprises:
receiving image data from the image capturing device located near the checkout lane; and
processing the image data to determine the quantity of items.

6. The method of claim 1, wherein the metrics include a cashier efficiency metric for the cashier operating the checkout lane.

7. The method of claim 1, further comprising:
determining a belt speed associated with the checkout lane,
wherein the metrics include the belt speed for the cashier associated with the checkout lane.

8. The method of claim 1, wherein the metrics include an input from the cashier associated with the checkout lane, the input indicating a number of items in one or more shopping carts or shopping baskets in the checkout lane associated with the cashier.

9. The method of claim 1, wherein the checkout lane parameter indicates a checkout speed for the cashier associated with a checkout lane or a progression speed of a queue at the checkout lane.

10. The method of claim 1, further comprising:
displaying the user interface on a display device located in proximity to a plurality of checkout lanes in the store, a mobile device of a customer in the store, or a plurality of display devices located at each of the plurality of checkout lanes.

11. A system for controlling a display to render data related to one or more queues, the system comprising:
a memory;
a processor configured to execute instructions stored in the memory, causing the system to:
generate a user interface including a graphical representation of the checkout lane, the graphical representation indicating at least a checkout lane number for the checkout lane;
query one or more databases to retrieve one or more metrics therefrom, the metrics including at least a cashier satisfaction rating for a cashier operating the checkout lane;
convert the retrieved metrics into a checkout lane parameter indicating a speed for the checkout lane or statistics associated with the cashier operating the checkout lane; and
render a graphical representation on the user interface indicating the checkout lane parameter for the checkout lane and the cashier satisfaction rating.

12. The system of claim 11, wherein the process is further configured to:
receive data related to detecting a quantity of shopping carts and a quantity of shopping baskets in the checkout lane using machine vision,
wherein the metrics include the quantity of shopping carts and the quantity of shopping baskets in the checkout lane.

13. The system of claim 11, wherein the processor is further configured to:
receive data related to sensing a quantity of items in one or more shopping carts or shopping baskets waiting in line at the checkout lane,
wherein the metrics include the quantity of items in one or more shopping carts or shopping baskets in the checkout lane.

14. The system of claim 13, wherein the processor is further configured to:
determine the number of items using data collected by one or more optical or acoustic sensors located at the checkout lane.

15. The system of claim 14, wherein the one or more sensors include an image capturing device and the process is further configured to:
receive image data from the image capturing device located near the checkout lane; and
process the image data to determine the quantity of items.

16. The system of claim 11, wherein the processor is further configured to:
determine a belt speed associated with the checkout lane,
wherein the metrics include the belt speed for the cashier associated with the checkout lane.

17. A non-transitory machine-readable medium storing instructions executable by a processing device, wherein execution of the instructions causes the processing device to implement a method for controlling a display to render data related to one or more queues, the method comprising:
generating a user interface including a graphical representation of the checkout lane, the graphical representation indicating at least a checkout lane number for the checkout lane;
querying one or more databases to retrieve one or more metrics therefrom, the metrics including at least a cashier satisfaction rating for a cashier operating the checkout lane;
converting the retrieved metrics into a checkout lane parameter indicating a speed for the checkout lane or statistics associated with the cashier operating the checkout lane; and
rendering a graphical representation on the user interface indicating the checkout lane parameter for the checkout lane and the cashier satisfaction rating.

18. The non-transitory machine-readable medium of claim 17, further comprising:
detecting a quantity of shopping carts and a quantity of shopping baskets in the checkout lane using machine vision,
wherein the metrics include the quantity of shopping carts and the quantity of shopping baskets in the checkout lane.

19. The non-transitory machine-readable medium of claim 17, further comprising:
sensing a quantity of items in one or more shopping carts or shopping baskets waiting in line at the checkout lane,
wherein the metrics include the quantity of items in one or more shopping carts or shopping baskets in the checkout lane.

20. The non-transitory machine-readable medium of claim 17, further comprising:
determining a belt speed associated with the checkout lane,
wherein the metrics include the belt speed for the cashier associated with the checkout lane.

21. The non-transitory machine readable medium of claim 17, wherein the metrics include a number of items in one or more shopping carts or shopping baskets in the checkout lane, and a checkout speed of the cashier operating the checkout lane; and
further comprising:
determining the checkout lane parameter from the number of items and the checkout speed of the cashier.

22. A system for controlling a display to render data related to one or more queues, the system comprising:
means for generating a user interface including a graphical representation of a checkout lane, the graphical representation indicating at least a checkout lane number for the checkout lane;
means for querying one or more databases to retrieve one or more metrics therefrom, the metrics including at least a cashier satisfaction rating for a cashier operating the checkout lane;
means for converting the retrieved metrics into a checkout lane parameter indicating a speed for the checkout lane or statistics associated with the cashier operating the checkout lane; and
means for rendering a graphical representation on the user interface indicating the checkout lane parameter for the checkout lane and the cashier satisfaction rating.
